(19) United States
(12) Patent Application Publication
(10) Pub. No.: US 2012/0151885 A1
(43) Pub. Date: Jun. 21, 2012

(54) AIR FILTER DEVICE AND ELECTRONIC DEVICE

(75) Inventors: Yosuke Nishihata, Hirakata-shi (JP); Akira Miyanaga, Daito-shi (JP); Yoshiharu Arioka, Osaka-shi (JP); Kazunori Kotani, Nara-shi (JP)

(73) Assignee: SANYO ELECTRIC CO., LTD., Osaka (JP)

(21) Appl. No.: 13/327,087

(22) Filed: Dec. 15, 2011

(30) Foreign Application Priority Data
Dec. 16, 2010 (JP) 2010-281029

(51) Int. Cl. B01D 46/42

(52) U.S. Cl. 55/289

(57) ABSTRACT

An air filter device includes an air filter that removes dust from air drawn into a device. The air filter includes an air filter surface. A brush including bristles removes dust from the air filter. The brush and the air filter are relatively moved in a direction orthogonal to a longitudinal direction of the brush while distal parts of the bristles of the brush penetrate the air filter surface to remove dust from the air filter. A unit for reducing or eliminating penetration reduces or eliminates penetration of the brush into the air filter when relative movement of the brush and the air filter is stopped.

### CROSS-REFERENCE TO RELATED APPLICATIONS

This application is based upon and claims the benefit of priority from prior Japanese Patent Application No. 2010-281029, filed on Dec. 16, 2010, the entire contents of which are incorporated herein by reference.

### BACKGROUND OF THE INVENTION

The present invention relates to an air filter device including a cleaning unit, which removes dust from an air filter with a brush, and an electronic device.

A conventional electronic device, such as a personal computer or a video projector, draws ambient air as cooling air into the device and directs the cooling air to components. In particular, a light source lamp, which is used as a light source for a video projector, becomes hot. Thus, components in optical system of the video projector, such as the light source lamp, are cooled with the cooling air.

In such an electronic device, an air filter is used to remove dust from the ambient air. Dust accumulates in the air filter as time elapses. As the amount of the accumulated dust increases, the air filter clogs, the amount of intake air drawn through the air filter decreases, and the cooling effect falls. For this reason, an air filter device including a cleaning unit that uses a brush to remove dust from an air filter has been developed.

Japanese Laid-Open Patent Publication No. 2007-156186 describes one example of a video projector including such an air filter device. The video projector includes an air inlet. An air filter, which removes dust, is arranged in the air inlet. A rotary brush moves back and forth on the air filter to remove dust from the air filter.

Japanese Laid-Open Patent Publication No. 2008-65021 describes another example of a video projector including an air filter device, which is unitized and arranged in an inlet for ambient air. The air filter device includes a pre-filter facing toward the inlet. The air filter device moves the pre-filter sideward back and forth along a plane. This produces friction between a fixed brush and an air filter.

In the video projector of Japanese Laid-Open Patent Publication No. 2007-156186, when the rotary brush stops in a state penetrated in the surface of the air filter, the frictional force produced between the rotary brush and the air filter increases when the rotary brush is subsequently driven. Further, in a case in which the rotary brush is moved from a standby position to an opposite end and the movement of the rotary brush is reversed to return the rotary brush to its original position, when reversing the rotary brush in a state in which it is penetrated in the surface of the air filter, the frictional force produced between the rotary brush and the air filter becomes large. However, Japanese Laid-Open Patent Publication No. 2007-156186 does not discuss any measures for preventing the rotary brush from being reversed when the rotary brush is penetrated in the surface of the air filter. Accordingly, in the video projector of Japanese Laid-Open Patent Publication No. 2007-156186, smooth movement of the rotary brush may be hindered.

The video projector of Japanese Laid-Open Patent Publication No. 2008-65021 has the same problem as that of the Japanese Laid-Open Patent Publication No. 2007-156186. In a case in which the distal parts of bristles on the fixed brush are penetrated in the surface of the pre-filter when the pre-filter stops, the frictional force produced between the fixed brush and the pre-filter becomes large when the movement of the pre-filter is subsequently started. Further, in a state in which the distal parts of the bristles of the fixed brush are penetrated in the surface of the pre-filter, the frictional force produced between the fixed brush and the pre-filter becomes large when reversing the direction in which the pre-filter moves. However, Japanese Laid-Open Patent Publication No. 2008-65021 does not discuss any measures for resolving such a problem. Accordingly, in the video projector of Japanese Laid-Open Patent Publication No. 2008-65021, smooth movement of the pre-filter may be hindered.

### SUMMARY OF THE INVENTION

One aspect of the present invention is an air filter device including an air filter that removes dust from air drawn into a device. The air filter includes an air filter surface. A brush including bristles removes dust from the air filter. The brush and the air filter are relatively moved in a direction orthogonal to a longitudinal direction of the brush while distal parts of the bristles of the brush penetrate the air filter surface to remove dust from the air filter. A unit for reducing or eliminating penetration reduces or eliminates penetration of the brush into the air filter when relative movement of the brush and the air filter is stopped.

A further aspect of the present invention is an electronic device including an air filter device. The air filter device includes an air filter that removes dust from air drawn into a electronic device. The air filter includes an air filter surface. A brush including bristles removes dust from the air filter. The brush and the air filter are relatively moved in a direction orthogonal to a longitudinal direction of the brush while distal parts of the bristles of the brush penetrate the air filter surface to remove dust from the air filter. A unit for reducing or eliminating penetration reduces or eliminates penetration of the brush into the air filter when relative movement of the brush and the air filter is stopped.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a video projector according to a first embodiment of the present invention from below;

FIG. 2 is a perspective view showing an air filter device in a state removed from the video projector of the first embodiment;

FIG. 3 is a bottom view showing the air filter device of FIG. 2;

FIG. 4 is a schematic block diagram showing the entire configuration of the video projector of the first embodiment;

FIG. 5(a) is a cross-sectional view showing the air filter device in a standby state, and FIG. 5(b) is a cross-sectional view showing the air filter device in a reversed state;

FIG. 6(a) is a schematic diagram showing a rotary brush penetrated in an air filter of the air filter device of FIG. 2 during a cleaning operation;

FIG. 6(b) is a schematic diagram showing the rotary brush penetrated in the air filter of the air filter device of FIG. 2 when reversed;

FIG. 6(c) is a referential diagram showing a state in which the rotary brush is penetrated in the air filter in the air filter device of FIG. 2 when reversed;

FIG. 7(a) is a cross-sectional view showing a video projector according to a second embodiment of the present invention during a cleaning operation;

FIG. 7(b) is a cross-sectional view showing the video projector of the second embodiment when reversed;

FIG. 8(a) is a schematic diagram showing an air filter device of a video projector according to a third embodiment of the present invention in a state in which a rack and pinion are engaged with each other during a cleaning operation;

FIG. 8(b) is a side view showing the rack and pinion in a state engaged with each other;

FIG. 8(c) is a schematic diagram showing the air filter device when reversed;

FIG. 9 is a bottom view showing an air filter device of a video projector according to a fourth embodiment of the present invention;

FIG. 10 is a schematic diagram showing an air filter device of a video projector according to a fifth embodiment of the present invention;

FIG. 11(a) is a schematic diagram showing an air filter device of a video projector according to a sixth embodiment of the present invention in a standby state;

FIG. 11(b) is a schematic diagram showing the air filter device during a cleaning operation;

FIG. 11(c) is a schematic diagram showing the air filter device when returning to the standby position;

FIG. 12(a) is a schematic diagram showing a modification of a rotary brush when stopped during a cleaning operation;

FIG. 12(b) is a schematic diagram showing the rotary brush of FIG. 12(a) when the cleaning operation is restarted from where it was stopped; and

FIG. 12(c) is a schematic diagram showing the rotary brush of FIG. 12(a) when the cleaning operation is started from the beginning after being stopped.

### DETAILED DESCRIPTION OF THE INVENTION

### First Embodiment

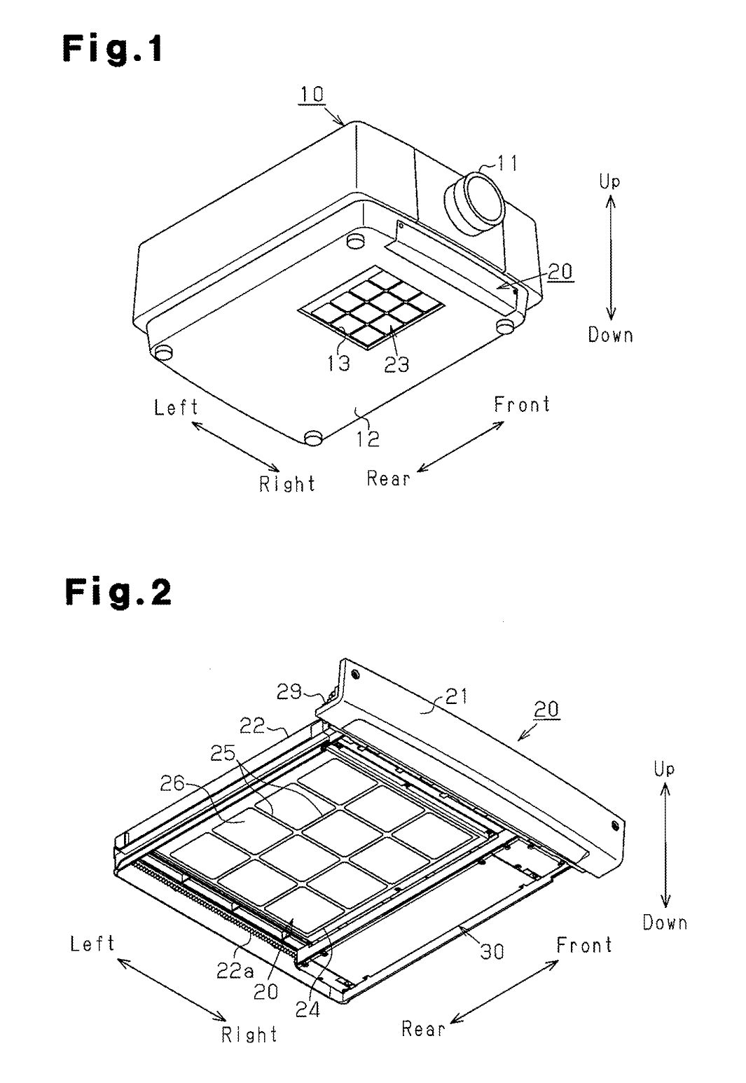

A video projector according to a first embodiment of the present invention will now be described with reference to FIGS. 1 to 6.

As shown in the perspective view of FIG. 1, the video projector of the first embodiment, which is a three-chip LCD projector, includes a box-shaped housing 10. In the description hereafter, the direction in which the video projector projects image light from a projection lens 11 is referred to as a frontward direction. The opposite direction is the rearward direction. When the video projector is set on a horizontal surface, the directions parallel to the horizontal surface and perpendicular to the frontward and rearward directions are referred to as leftward and rightward directions. The frontward, rearward, leftward, rightward, upward, and downward directions are indicated by arrows in each drawing.

The housing 10 includes a bottom surface 12. When the video projector is set on a horizontal surface, the bottom surface 12 faces the horizontal surface. The bottom surface 12 includes an air inlet 13 through which ambient air is drawn. The ambient air is used as cooling air that cools components in the housing 10, such as a light source and optical components. As shown in FIG. 1, an air filter device 20 is arranged in the air inlet 13 to remove dust from the ambient air drawn into the projector.

The air filter device 20 used in the video projector of the first embodiment will now be described.

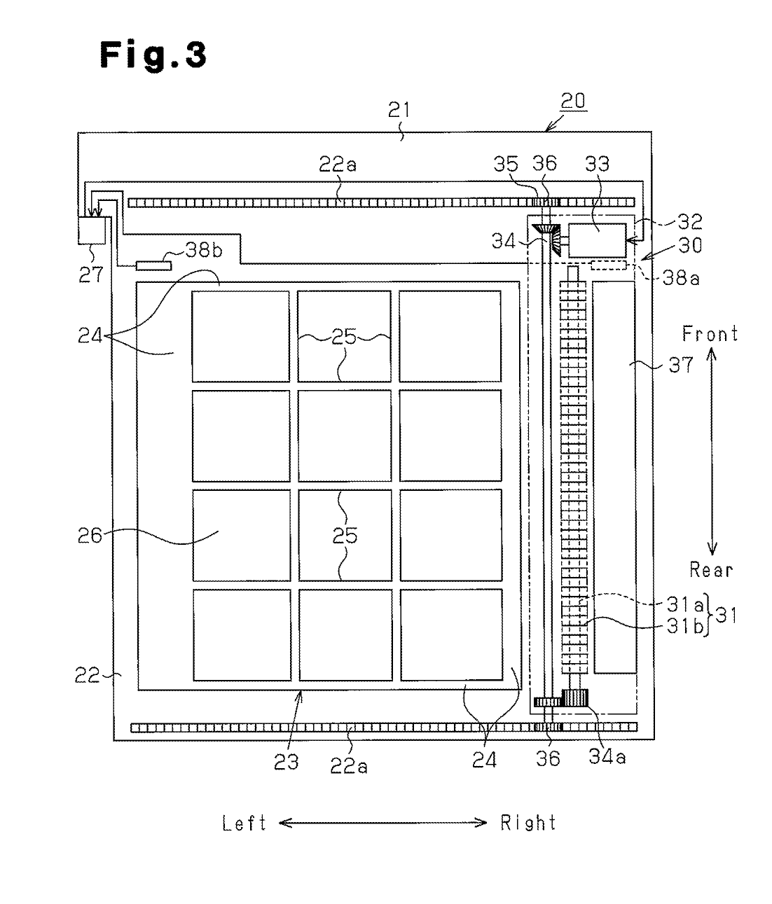

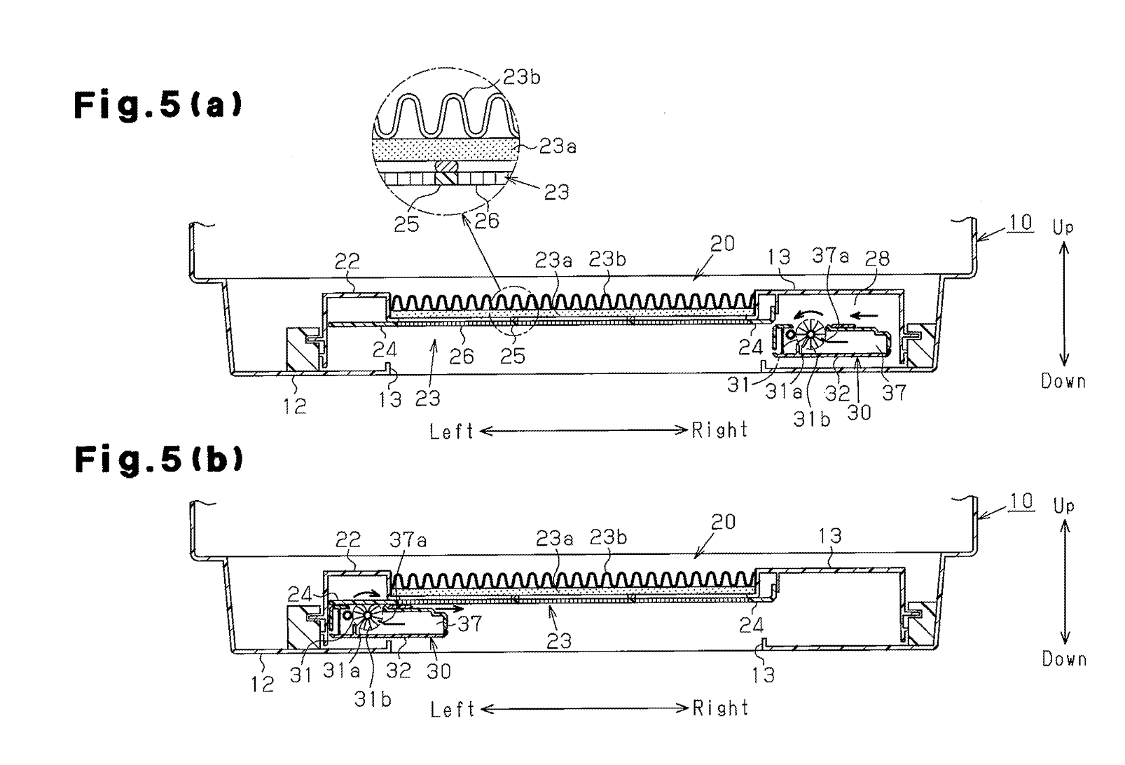

The air filter device 20 is arranged in a bottom portion of the housing 10. The air filter device 20 can be removed from the front of the housing 10 by sliding the air filter device 20. FIG. 3 shows the air filter device 20 in a state removed from the housing 10. The air filter device 20 includes an L-shaped handle 21 and a base material 22 arranged at the inner side of the handle 21. The base material 22 is formed from a resin and includes a tetragonal opening shaped in conformance with the air inlet 13. An air filter 23 is arranged on the base material 22 to cover the opening and capture dust. As shown in the cross-sectional diagram of FIG. 5, to capture dust from the drawn in ambient air, a secondary filter 23a and tertiary filter 23b are arranged above the air filter 23, that is, above the opening. The air filter 23 functions as a pre-filter in relation to the filters 23a and 23b. The cleaning function of the air filter device 20 in the present invention is implemented on only the air filter 23, or pre-filter, and not implemented on the secondary filter 23a and tertiary filter 23b.

As shown in FIGS. 2 and 3, the air filter 23 includes a peripheral frame 24, a grid frame 25, and a filtering material 26. The peripheral frame 24 is flat and includes a rectangular contour. The grid frame 25 divides an inner region of the peripheral frame 24 into a plurality of sections. The filtering material 26 is arranged in each of these sections. The peripheral frame 24 and the grid frame 25 are molded integrally with each other. The filtering material 26 is adhered or fused to the peripheral frame 24 and grid frame 25. The peripheral frame 24, grid frame 25, and filtering material 26 have generally the same thickness. The air filter 23 has a generally flat surface. In the present invention, the frames of a filter refer to the peripheral frame 24, which forms the periphery of the filter (in this case, the air filter 23), and the grid frame 25, which divides the inner region of the peripheral frame 24 into a plurality of regions.

The left portion of the peripheral frame 24 is relatively wide so that the direction in which a rotary brush 31 can be reversed on the peripheral frame 24. The wide left portion of the peripheral frame 24 that allows the movement direction of the rotary brush 31 to be reversed functions as a unit for reducing or eliminating penetration of the brush into the air filter in the present invention.

Two racks 22a are fastened by screws to the front and rear of the air filter 23.

The base material 22 has a front side including a connector 27 that is electrically connected to a main body of the video projector when the air filter device 20 is attached to the housing 10. The connection of the connector 27 to the main body supplies power from the video projector to the air filter device 20.

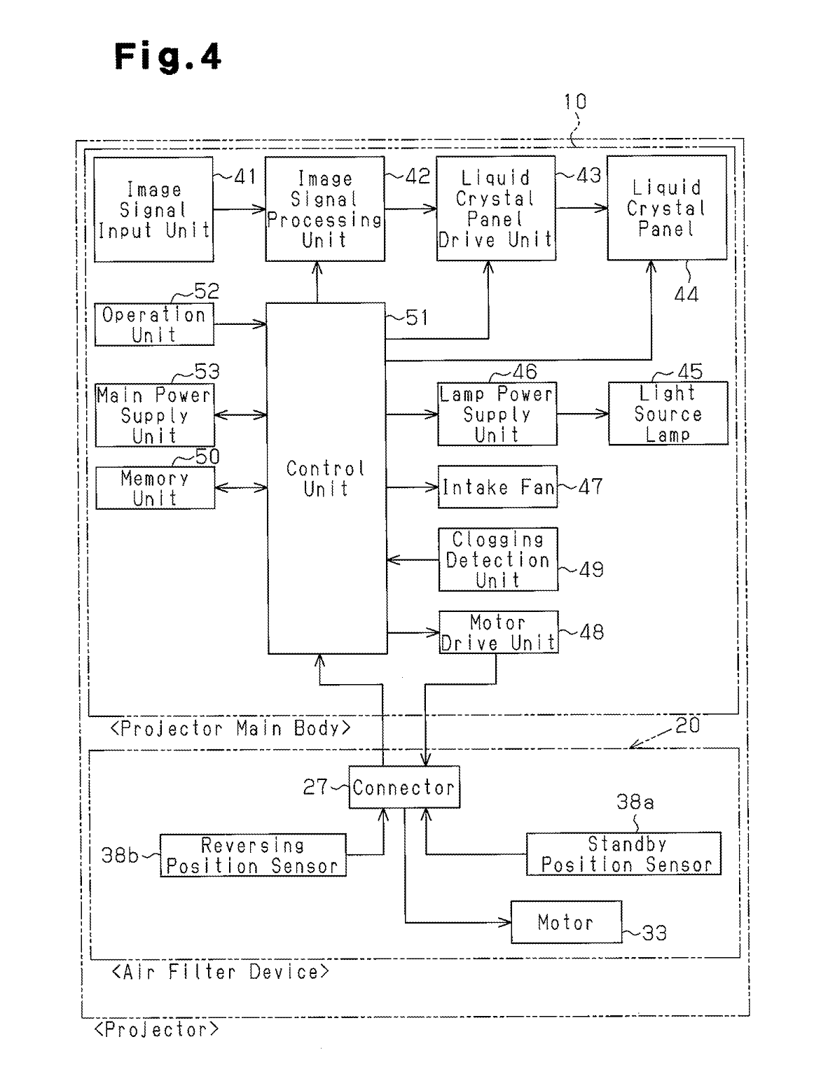

As shown in FIGS. 3 and 4, the air filter device 20 includes a cleaning unit 30, which cleans the air filter 23. The cleaning unit 30 is arranged in an open space (refer to FIG. 5) provided at the right side of the air filter 23.

The cleaning unit 30, which is generally box-shaped, accommodates and supports the rotary brush 31 in a rotatable manner. The rotary brush 31 removes dust from the air filter 23 while penetrating the air filter 23. The rotary brush 31 is fixed to the cleaning unit 30 and functions as part of the cleaning unit 30. The cleaning unit 30 is moved to remove dust from the air filter 23. This moves the rotary brush toward the left and right while being rotated and pressed against the surface of the air filter 23. Thus, the rotary brush 31 rotates as the distal parts of its bristles penetrate the air filter 23. During the cleaning operation, referring to FIG. 5(a), the rotary brush 31 is first forcibly rotated in the counterclockwise direction from a right position toward the left. When the rotary brush 31 reaches the left end of the air filter 23, the rotation direction and moving direction of the rotary brush 31 are reversed, and the rotary brush 31 is returned to the right position (refer to FIG. 5(b)). In this manner, a single reciprocation of the rotary brush 31 in the leftward and rightward directions while rotating along the surface of the air filter 23 removes dust from the air filter 23.

The right position is a standby position at which the cleaning unit 30 waits and does not move when not cleaning the air filter 23. The standby position is set so that the cleaning unit 30 is not overlapped with the air filter 23 as viewed from a direction perpendicular to the air filter surface. At the standby position, the cleaning unit 30, which incorporates the rotary brush 31, is located in an open space 28 as shown in FIG. 5(a) and is not in contact with the air filter 23. In this manner, when the cleaning unit 30 stops at the standby position, the structure that positions the rotary brush 31 in the open space 38 at the outer side of the air filter 23 as viewed from a direction perpendicular to the air filter surface functions as a unit for reducing or eliminating penetration of the brush into the air filter in the present invention.

The structure of the cleaning unit 30 is shown in FIGS. 2, 3, and 5. The cleaning unit 30 includes a case 32, which is elongated in the frontward and rearward directions, a motor 33, which serves as a drive unit, a drive shaft 34, which is driven by the motor 33, and racks 35. The cleaning unit 30 further includes pinions 36, which are engaged with the racks 35 and rotated by the drive shaft 34, the rotary brush 31, to which rotation of the drive shaft 34 is transmitted, a gear 34a, which transmits the rotation of the drive shaft 34 to the rotary brush 31, and a dust box 37, which collects dust. The motor 33, drive shaft 34, and rotary brush 31 are accommodated in the case 32.

The motor 33 rotates the rotary brush 31 and moves the case 32, which incorporates the rotary brush 31, in predetermined directions (leftward and rightward directions). As shown in FIG. 3, the motor 33 transmits torque via the drive shaft 34 to the pinions 36 and the rotary brush 31.

The drive shaft 34 is supported in a rotatable manner by the case 32 so as to extend over the air filter 23 from the front toward the rear. The pinions 36 are fixed to the front and rear ends of the drive shaft 34.

As shown in FIG. 3, the pinions 36 are engaged with the racks 35, which are horizontally arranged outside the case 32. Accordingly, the drive shaft 34 is rotated to transmit force to the rotary brush 31 via the gear 34a. This horizontally moves the case 32, which accommodates the rotary brush 31 in a rotatable manner, in leftward and rightward directions as shown in FIG. 5(a). When moving the case toward the left and right, the rotary brush 31 is pressed against the air filter 23 and rotated to remove dust from the air filter 23.

The rotary brush 31 includes a rod 31a and bristles 31b, which are arranged on the rod 31a. The rod 31a is supported by the case 32 at front and rear ends of the rotary brush 31 so that the case 32 supports the rotary brush 31 in a rotatable manner. When the rotary brush 31 moves along the air filter 23, the bristles 31b of the rotary brush 31 penetrate the filtering material 26 of the air filter 23. Movement of the rotary brush 31 along the surface of the air filter 23 as the distal ends of the bristles 31b penetrate the filtering material 26 cleans the filtering material 26 of the air filter 23. Further, the dust on the bristles 31b of the rotary brush 31 is removed by a dust removal plate 37a, which is arranged in the dust box 37, and collected in the dust box 37 (refer to FIG. 5).

A standby position sensor 38a is arranged at the right side of the base material 22 in the air filter device 20. A reversing position sensor 38b is arranged at the left side of the base material 22 in the air filter device 20. The standby position sensor 38a is a switch that detects that the cleaning unit 30 has reached the predetermined standby position. The reversing position sensor 38b is a switch that detects that the cleaning unit 30 has reached the predetermined reversing position. The standby position sensor 38a and the reversing position sensor 38b are connected to the connector 27 and send signals indicating the location of the cleaning unit 30, which includes the rotary brush 31, to the connector 27.

The structure of the video projector including the air filter device 20 will now be described with reference to the block diagram of FIG. 4.

As elements for generating an image, the video projector includes an image signal input unit 41, an image signal processing unit 42, a liquid crystal panel drive unit 43, a liquid crystal panel 44, a light source lamp 45, and a lamp power supply unit 46.

The image signal input unit 41 receives image signals from various image reproduction devices. An image signal input to the image signal input unit 41 undergoes processing such as A/D conversion and decoding and is converted to a digital signal and provided to the image signal processing unit 42.

The image signal processing unit 42 performs typical image processing on the input image signal, such as scaling, gamma correction, and brightness correction. An image signal that has undergone such processing is sent to the liquid crystal panel drive unit 43.

The liquid crystal panel drive unit 43 converts the image signal from the image signal processing unit 42 into a signal format that drives liquid crystal cells for red light, green light, and blue light. The liquid crystal panel drive unit 43 simultaneously generates drive pulses for driving the liquid crystal cells for green light, red light, and blue light.

The liquid crystal panel 44 includes the liquid crystal cells for red light, green light, and blue light. Each liquid crystal cell has a rotational angle that is in accordance with the input image signal and generates an image by passing light from a separation optical system. The projection lens 11 projects and displays the image on a screen, which is separated by a predetermined distance from the video projector.

The light source lamp 45, which is a discharge lamp such as a metal halide lamp or an ultrahigh-pressure mercury lamp, uses a reflector to produce and emit collimated light from the light emitted from a light emission body. The light source lamp 45 becomes hot during use and requires to be cooled. The light generated by the light source lamp 45 is sent by an optical system to the liquid crystal panel 44.

The video projector further includes an intake fan 47, a motor drive unit 48, a clogging detection unit 49, and a memory unit 50, which are related to a cooling system for optical system devices.

The intake fan 47 draws in ambient air and sends cooling air to the devices that become hot such as the light source lamp 45, the liquid crystal panel 44, and the lamp power supply unit 46. The ambient air is drawn into the video projector through the air filter device 20.

The motor drive unit 48 drives and controls the motor 33 of the cleaning unit 30. When removing dust from the air filter 23, the motor 33 is driven to rotate the rotary brush 31 and move the cleaning unit to the reversing position, which is located at the left end as viewed in the drawing. When the cleaning unit 30 reaches the predetermined reversing position, based on the information from the reversing position sensor 38b, the motor 33 is driven to return the cleaning unit 30 to its original standby position. When the cleaning unit 30 is reversed and returned to the predetermined standby position, the standby position sensor 38a is activated, the motor 33 is deactivated, and the movement of the cleaning unit 30 is stopped.

In the first embodiment, when clogging occurs in the air filter 23, the output voltage of an air flow sensor in the clogging detection unit 49 changes. The clogging detection unit 49 compares a change in the output voltage with a voltage threshold stored in the memory unit 50 to determine whether clogging is occurring.

The memory unit 50 includes a ROM and a non-volatile RAM. In addition to programs for controlling the entire video projector, the memory unit 50 stores the information required to determine clogging of the air filter 23 and a program for a cleaning operation sequence that controls the air filter device 20. The control unit 51 uses the information and programs stored in the memory unit 50 to control the air filter device 20.

The video projector includes a control unit 51, which controls the entire projector, an operation unit 52, and a main power supply unit 53.

The control unit 51 exchanges signals with various parts of the projector and controls each part so that the entire video projector operates smoothly. When driving the air filter device 20, the control unit 51 transmits controls signals that are required to drive the motor drive unit 48 while receiving information from the standby position sensor 38a and the reversing position sensor 38b.

The operation unit 52 is operated by a user and includes an operation switch, keys, a remote controller, and an external computer. The control unit 51 processes the information input by the operation unit 52. The contents of operations based on the input information are sent from the control unit 51 to each part and performed.

The main power supply unit 53 is supplied with AC power from an external power supply. The main power supply unit 53 includes an AC/DC converter. The AC/DC converter performs processing such as voltage transformation, rectification, and smoothing on the AC power and supplies each part with stable DC power.

The operation of the air filter device will now be described.

When clogging of the air filter 23 is detected by the clogging detection unit 49 during operation of the video projector, the air filter device 20 is controlled to perform automatic cleaning.

When a command for starting an automatic cleaning operation is issued, the motor 33 of the cleaning unit 30 is driven. This drives the pinions 36, which are engaged with the racks 22a, and the cleaning unit 30 is moved leftward from the standby position, which is shown in FIG. 5(a). As the cleaning unit 30 moves leftward from the standby position and until the cleaning unit 30 enters the cleaning process, the rotary brush 31 is not in contact with the air filter 23 or any other part. Thus, the rotation load is extremely small when the rotary brush 31 is actuated. Further, the rotary brush 31 is moved leftward, which is orthogonal to the longitudinal direction of the rotary brush 31, while rotating when the cleaning operation starts. Thus, the rotary brush is smoothly rotated and driven.

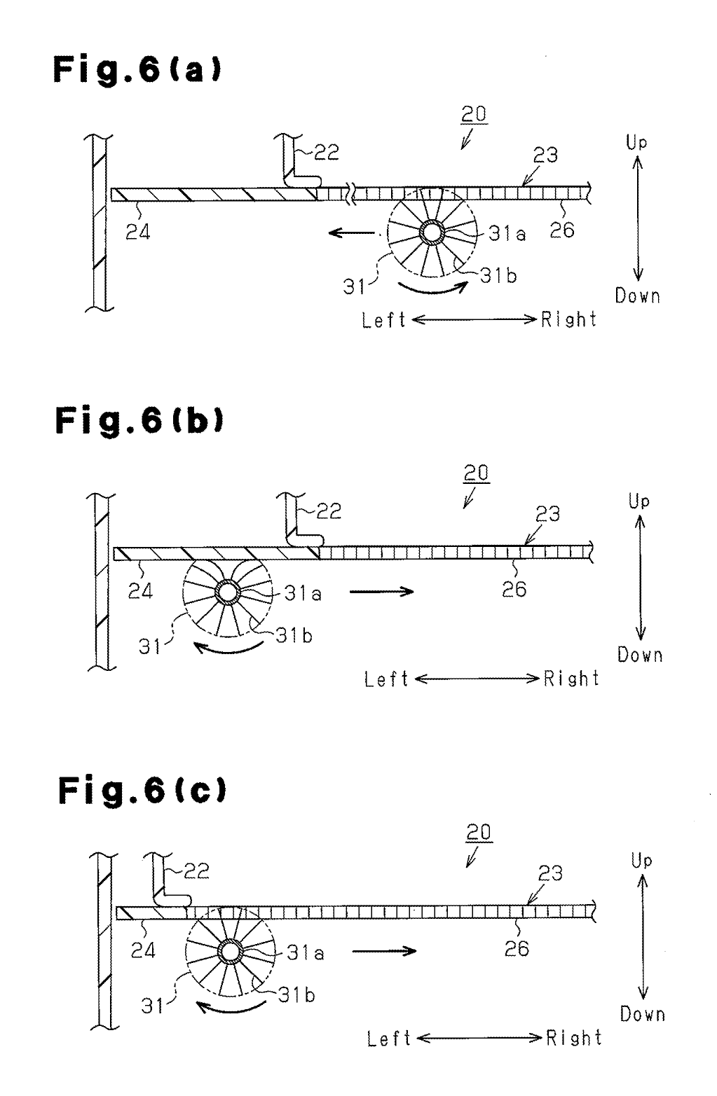

The operation performed after the cleaning operation starts will now be described in further detail with reference to FIG. 6.

During the cleaning operation, as shown in FIG. 6(a), the rotary brush 31 and the air filter 23 move relative to each other as distal parts of the bristles 31b of the rotary brush 31 penetrates the filtering material 26 of the air filter 23. As the cleaning operation starts and the rotary brush 31 moves leftward, the rotary brush 31 rotates in a direction opposite to the relative movement direction of the air filter 23, that is, the counterclockwise direction as viewed in FIG. 6(a). Thus, dust is efficiently removed from the filtering material 26 of the air filter 23. The dust on the rotary brush 31 from the air filter 23 is removed by the dust removal plate 37a and collected in the dust box 37.

In this manner, as the rotary brush 31 moves to the left end and reaches the predetermined reversing position, the reversing position sensor 38b is activated, and the rotation generated by the motor 33 is reversed. This reverses and moves the case 32 toward the original standby position. In this state, the rotary brush 31 is located on the peripheral frame 24 of the air filter 23. Thus, the bristles 31b do not penetrate the surface of the filtering material 26 in the air filter 23, and the distal parts of the bristles 31b are in contact with the surface of the peripheral frame 24. A state in which the bristles 31b penetrate the surface of the filtering material 26 in the air filter 23 refers to a state in which the distal parts of the bristles 31b are arranged in the holes of the filtering material 26. The reversing position decreases the frictional resistance between the rotary brush 31 and the air filter 23 and smoothly reverses movement. When such a measure is not taken and the width of the peripheral frame 24 is small, as shown in FIG. 6(c), the movement of the case 32 would be reversed in a state in which the distal parts of the bristles 31b are still penetrating the filtering material 26. This increases frictional resistance of the rotary brush 31 and the air filter 23 and hinders smooth reversing of the movement of the case 32.

From the reversing process to the returning process, during which the case 32 returns to the standby position, the rotation of the motor 33 is reversed, and the rotary brush 31 is moved toward the standby position, that is, rightward. Further, the rotary brush 31 is moved in a direction opposite to the relative movement direction of the air filter 23, that is, the clockwise direction. Thus, dust is efficiently removed from the filtering material 26 of the air filter 23. The dust on the rotary brush 31 from the air filter 23 is removed by the dust removal plate 37a and collected in the dust box 37. When the rotary brush 31 returns to the standby position, the standby position sensor 38a is activated, and the motor 33 is deactivated. This ends the cleaning operation that cleans the air filter 23. At the standby position, the cleaning unit 30 is stopped in an open space located outside the air filter 23 when viewed from a direction perpendicular to the surface of the air filter 23. Accordingly, the cleaning unit 30 is stopped in a state in which the rotary brush 31 does not penetrate the air filter 23.

The air filter device 20 in the video projector of the first embodiment has the advantages described below.

(1) In the first embodiment, the air filter device 20 is configured so that when the relative movement of the rotary brush 31 and the air filter 23 is stopped, penetration of the rotary brush 31 in the air filter 23 is eliminated. This eliminates frictional resistance between the rotary brush 31 and the air filter 23 when the rotary brush 31 commences movement from a stopped state, and the rotary brush 31 and air filter 23 are relatively moved smoothly. Accordingly, the air filter device 20 has superior operational stability and reliability and is economic.

(2) In the first embodiment, when relative movement of the rotary brush 31 and the air filter 23 is stopped and reversed, the air filter device 20 reduces penetration of the rotary brush 31 in the air filter 23. Accordingly, when commencing movement from a stopped state and when reversing relative movement of the rotary brush 31 and the air filter 23, the frictional resistance is decreased, and the relative movement of the rotary brush 31 and air filter 23 is smoothly performed. Thus, the air filter device 20 has superior operational stability and reliability and is economic.

(3) In the first embodiment, the rotary brush 31 is moved, and the air filter 23 is not moved. This reduces the space occupied by the air filter 23. Further, dust is efficiently removed from the air filter 23.

(4) In the first embodiment, a unit for reducing or eliminating penetration of the brush into the air filter is configured so that the distal parts of the bristles 31b of the rotary brush 31 contact the peripheral frame 24 of the air filter 23 at the position at which the relative movement of the rotary brush 31 and the air filter 23 is reversed. Accordingly, when reversing the relative movement, the amount of bristles 31b penetrating the filter member of the air filter 23 is reduced, and the frictional resistance between the rotary brush 31 and the air filter 23 is decreased.

(5) In the first embodiment, a unit for reducing or eliminating penetration of the brush into the air filter is configured so that the position at which the relative movement of the rotary brush 31 and the air filter 23 stops is set at a position in which the rotary brush 31 is arranged in the open space outside the air filter 23 as viewed from a direction perpendicular to the surface of the air filter 23. Accordingly, when relative movement of the rotary brush 31 and the air filter 23 stops, penetration of the rotary brush 31 in the air filter 23 is eliminated. This decreases the frictional resistance produced between the rotary brush 31 and the air filter 23.

The video projector that functions as the electronic device of the first embodiment also has the following advantage.

(6) In the first embodiment, the electronic device includes the air filter device 20. This stabilizes the automatic cleaning operation of the air filter device 20 and allows the cleaning operation to be performed with high reliability.

### Second Embodiment

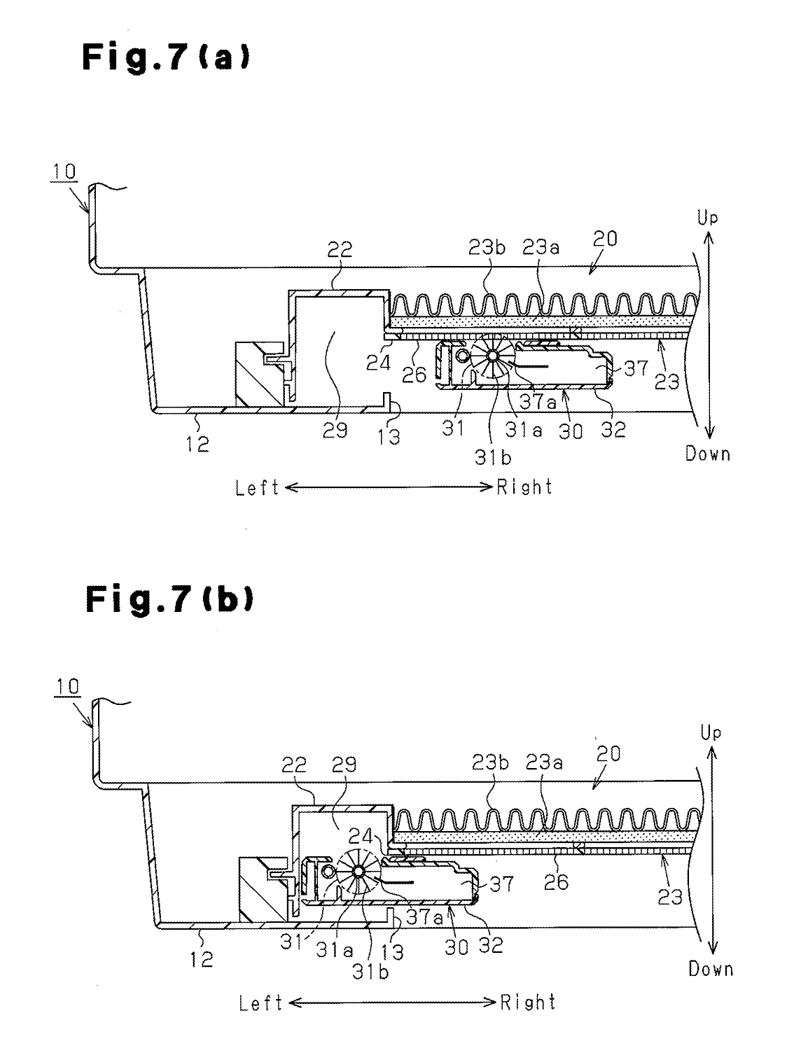

A video projector serving as an electronic device according to a second embodiment of the present invention will now be described with reference to FIG. 7. Like or same reference numerals are given to those components that are the same as the corresponding components of the first embodiment.

The second embodiment differs from the first embodiment in the structure of the unit for reducing or eliminating penetration of the brush into the air filter when reversing relative movement of the brush and air filter.

In this embodiment, the air filter 23 is reduced in size so that the rotary brush 31 does not contact the air filter 23 and the base material 22 at the reversing position, which is located at the left end of the air filter 23. An open space 29 is provided at the outer left side of the air filter 23 as viewed from a direction perpendicular to the air filter surface. In this manner, the structure that positions the rotary brush 31 in the open space 29 at the outer left side of the air filter 23 as viewed from a direction perpendicular to the air filter surface when the rotary brush is reversed forms a unit for reducing or eliminating penetration of the brush into the air filter.

The operation of the air filter device 20 of the second embodiment will now be described.

Referring to FIG. 7(a), when the air filter device 20 performs a cleaning operation, the cleaning unit 30 moves leftward as the rotary brush 31 penetrates the filtering material 26 of the air filter 23. Referring to FIG. 7(b), when the cleaning unit 30 is reversed at the left end of the air filter 23, the side surface of the cleaning unit 30 is located near the base material 22. Further, the rotary brush 31 is arranged in the open space 29 at the left side of the air filter 23. At this position, the rotary brush 31 does not contact the air filter 23 or the base material 22. Thus, the load applied when reversing the rotary brush 31 is extremely small, and the rotary brush 31 can thus be smoothly reversed.

In addition to advantages (1) to (3) and (5), the electronic device of the first embodiment has the following advantage.

(7) In the filter device of the second embodiment, the open space 29 is arranged at the outer left side of the air filter 23 as viewed from a direction perpendicular to the air filter surface, and the rotary brush 31 is arranged in the open space 29. Accordingly, when the relative movement of the rotary brush 31 and the air filter 23 is reversed, the penetration of the rotary brush 31 in the air filter surface is eliminated. This drastically decreases drive load when the rotary brush 31 is reversed.

### Third Embodiment

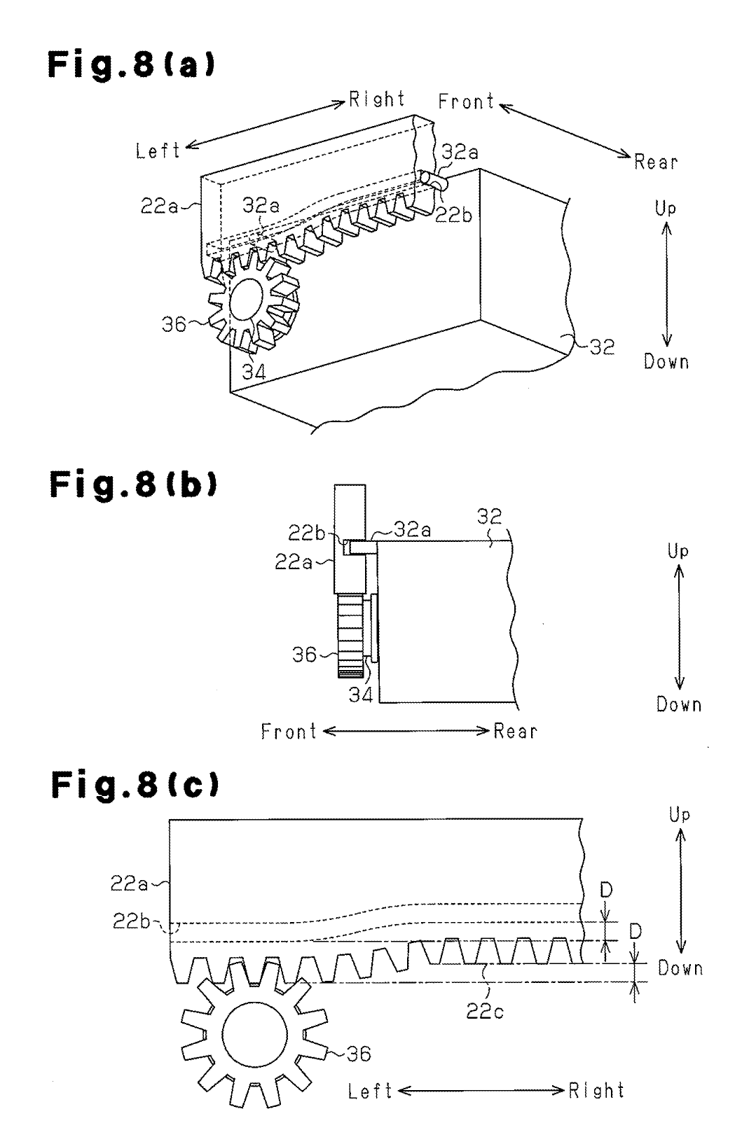

A video projector serving as an electronic device according to a third embodiment of the present invention will now be described with reference to FIG. 8. Like or same reference numerals are given to those components that are the same as the corresponding components of the first embodiment.

The third embodiment differs from the first embodiment in the structure of the unit for reducing or eliminating penetration of the brush into the air filter when reversing relative movement of the brush and air filter. In the third embodiment, the distance is increased between the rotary brush 31 and the air filter surface in a direction orthogonal to the air filter surface at the reversing position, which is located at the left end of the air filter 23.

A moving mechanism of the cleaning unit 30 will now be described. The moving mechanism is basically the same as that of the first embodiment.

Referring to FIGS. 8(a) and 8(b), torque is transmitted by the drive shaft 34 from the motor 33 to the front and rear pinions 36. The engagement of the pinions 36 with the racks 22a moves the case 32 in the leftward and rightward directions. In this embodiment, each rack 22a includes a groove 22b, which receives two cylindrical projections 32a projecting from the case 32. The projections 32a move in the corresponding grooves 22b so that the case 32 is not displaced upward and downward during a cleaning operation.

When the case 32 reaches the left end of the air filter 23 at which the relative movement of the rotary brush 31 and the air filter 23 is revered, the distance between the rotary brush 31 and the air filter surface is increased as shown in FIG. 8. More specifically, as shown in FIGS. 8(a) and 8(c), the rack 22a and groove 22b are formed so that the grooves 22b of the racks 22a and tooth tip lines 22c are descended downward by dimension D. Since one of the projections 32a are descended by dimension D in each groove 22b, the distance between the rotary brush 31 and the surface of the air filter 23 is increased by dimension D. Such a structure of the third embodiment forms a unit for reducing or eliminating penetration of the brush into the air filter.

The operation of the air filter device 20 in the third embodiment will now be described.

In the air filter device 20, the cleaning unit 30 moves in the same manner as the first embodiment during the cleaning operation while keeping the amount of the rotary brush 31 penetrated in the air filter surface generally constant. However, when the cleaning unit 30 reaches the left end of the air filter 23, as shown in FIGS. 8(a) and 8(c), the tooth tip lines 22c and the grooves 22b are descended downward by dimension D. This increases the distance between the rotary brush 31 and the surface of the air filter 23 by dimension D. Accordingly, in the present embodiment, when reversing the movement direction of the cleaning unit 30, the width of the peripheral frame 24 at the left side of the air filter 23 does not have to be increased like in the first embodiment. In this case, the distance between the rotary brush 31 and the surface of the air filter 23 is increased. This shortens the penetrated length of the bristles 13b in the surface of the air filter 23 or eliminates penetration of the bristles 13b. Thus, the frictional resistance produced between the rotary brush 31 and the air filter 23 can be decreased or eliminated.

In addition to advantages (1) to (3) and (5) of the first embodiment, the air filter device 20 of the third embodiment has the advantages described below. The electronic device of the third embodiment has the same advantages as the first embodiment.

(8) The distance between the rotary brush 31 and the air filter 23 is increased in a direction orthogonal to the air filter 23 at a position where the relative movement of the rotary brush 31 and the air filter 23 is reversed. This decreases the penetrated length and penetrated amount of the bristles 31b in the filtering material 26 of the air filter 23. Accordingly, the frictional resistance produced between the rotary brush 31 and the air filter 23 can be decreased or eliminated.

### Fourth Embodiment

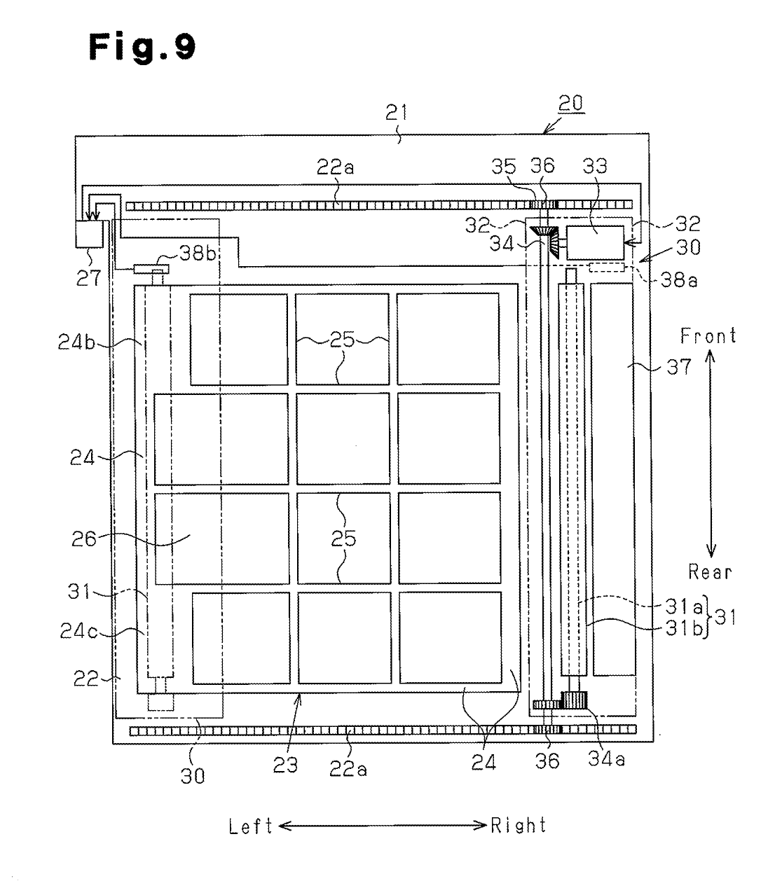

A video projector serving as an electronic device according to a fourth embodiment of the present invention will now be described with reference to FIG. 9. Like or same reference numerals are given to those components that are the same as the corresponding components of the first embodiment.

The fourth embodiment differs from the first embodiment in the structure of the unit for reducing or eliminating penetration of the brush into the air filter when reversing relative movement of the brush and air filter. In the fourth embodiment, the dimension of the air filter 23 in the longitudinal direction is relatively small at the position where the relative movement of the rotary brush 31 and the air filter 23 is reversed.

In the present embodiment, instead of entirely increasing the width of the peripheral frame 24 at the left side of the air filter 23 where the reversing position of the rotary brush 31 is located, the width is increased only at a front portion 24b and rear portion 24c of the peripheral frame 24 at the left side of the air filter 23. This decreases the dimension of the air filter 23 in the longitudinal direction of the rotary brush 31. In this manner, the structure that decreases the dimension of the air filter 23 in the longitudinal direction of the rotary brush 31 at the reversing position of the rotary brush 31 functions as a unit for reducing or eliminating penetration of the brush into the air filter.

The operation of the air filter device 20 in the fourth embodiment will now be described.

In the air filter device 20, in the same manner as the first embodiment, the cleaning unit 30 moves leftward during the cleaning operation while the rotary brush 31 penetrates the surface of the air filter 23. When the cleaning unit 30 reaches the left end of the air filter 23 and is reversed, as shown by the double-dashed lines in FIG. 9, the front and rear parts of the rotary brush 31 contact the front portion 24b and rear portion 24c of the peripheral frame 24. Only the middle part of the rotary brush 31 penetrates the filtering material 26 of the air filter 23. Accordingly, when the relative movement of the rotary brush 31 and the air filter 23 is reversed, the bristles 31b of the rotary brush 31 that penetrate the filtering material 26 of the air filter 23 is decreased. This decreases the frictional resistance produced between the rotary brush 31 and the air filter 23. Such a structure suppresses widening of the peripheral frame while preventing the filtering area of the air filter 23 from decreasing.

In addition to advantages (1) to (3) and (5) of the first embodiment, the air filter device 20 of the fourth embodiment has the advantages described below. The electronic device of the fourth embodiment has the same advantages as the first embodiment.

(9) In the fourth embodiment, the unit for reducing or eliminating penetration of the brush into the air filter reduces the dimension of the air filter 23 in the longitudinal direction of the rotary brush 31 at a position where the relative movement of the rotary brush 31 and the air filter 23 is reversed. Accordingly, in the present embodiment, when the relative movement of the rotary brush 31 and the air filter 23 is reversed, the bristles 31b of the rotary brush 31 that penetrate the filtering material 26 of the air filter 23 is decreased. This decreases the frictional resistance produced between the rotary brush 31 and the air filter 23.

### Fifth Embodiment

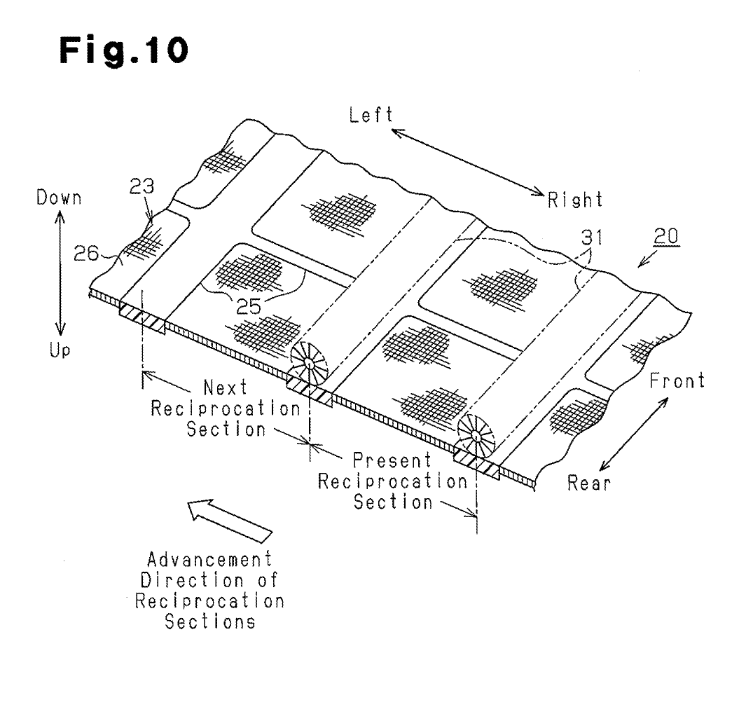

A video projector serving as an electronic device according to a fifth embodiment of the present invention will now be described with reference to FIG. 10. Like or same reference numerals are given to those components that are the same as the corresponding components of the first embodiment.

In the fifth embodiment, the rotary brush 31 can be reversed on each row of the grid frame 25.

In the air filter device 20 of the fifth embodiment, the width of each longitudinal bar extending in the frontward and rearward directions is greater than the width of each lateral bar in the grid frame 25 extending in the leftward and rightward directions. The rotary brush 31 can be reversed on the longitudinal bars of the grid frame 25 with a relatively small frictional resistance. The rotary brush 31 is not moved at once from the right standby position to the left reversing position. Rather, the rotary brush 31 is reciprocated a number of times in each row of the grid frame 25. During the reciprocation, in the same manner as in the first embodiment, the rotary brush 31 is forcibly rotated when moved in the leftward and rightward directions to remove dust from the air filter 23. The structure in which the longitudinal bars of the grid frame 25 are wide forms a unit for reducing or eliminating penetration of the brush into the air filter.

The operation of the air filter device 20 in the fifth embodiment will now be described.

The rotary brush 31 is moved leftward from the standby position but controlled to reciprocate a number of times in the leftward and rightward directions for each row. After a number of reciprocations end, the rotary brush 31 moves to the next row. When the cleaning of the leftmost row ends, the rotary brush 31 returns to its original standby position in the same manner as the first embodiment.

In addition to advantages (1) to (5) of the first embodiment, the air filter device 20 of the fifth embodiment has the advantages described below. The electronic device of the fifth embodiment has the same advantages as the first embodiment.

(10) In the fifth embodiment, the unit for reducing or eliminating penetration of the brush into the air filter is formed so that the distal parts of the bristles 31b of the rotary brush 31 contact the grid frame 25 of the air filter 23. This decreases the penetrated amount of the bristles 31b in the filtering material 26 of the air filter 23 and decreases the frictional resistance produced between the rotary brush 31 and the air filter 23.

(11) In the fifth embodiment, the cleaning unit 30 performs the cleaning operation a number of times on each row of the air filter 23. Thus, the cleaning operation can be thoroughly performed.

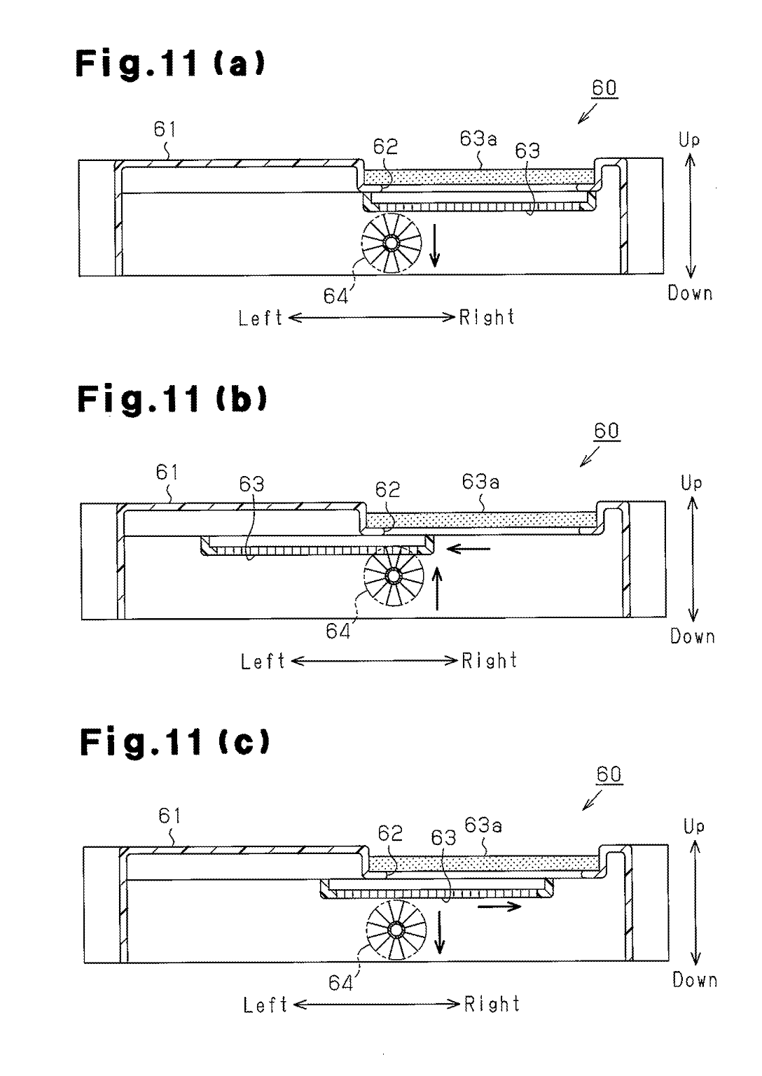

A video projector serving as an electronic device according to a sixth embodiment of the present invention will now be described with reference to FIG. 11.

An air filter device 60 of the sixth embodiment functions as a filter unit. In the same manner as the first embodiment, the air filter device 60 is coupled to the video projector from the front side and arranged in an air inlet arranged in a bottom surface of the video projector. A base material 61 of the air filter device 60 includes an opening 62 corresponding to the air inlet. An air filter 63 slides in the leftward and rightward directions relative to the opening 62. A secondary filter 63a is fixed to the upper side of the opening 62. A rotary brush 64 is coupled to the lower side of the air filter 63 at the middle part of the base material 61 in the leftward and rightward directions. The position of the rotary brush 64 is adjustable in the upward and downward directions.

The operation of the air filter device 60 will now be described.

When the air filter device 60 is in the standby state and does not perform a cleaning operation, as shown in FIG. 11(a), the air filter 63 covers the opening 62. Further, the rotary brush 64 is lowered to a lower position so that the distal ends of its bristles do not penetrate the air filter 63.

In a cleaning operation that removes dust from the air filter 63, referring to FIG. 11(b), the air filter device 63 moves leftward and the rotary brush 64 is lifted to an upper position. This penetrates the distal parts of the bristles of the rotary brush 64 in the moving air filter 63. When the air filter 63 reaches a left end position, cleaning is completed. Then, the rotary brush 64 is lowered again to the lower position. Further, the movement direction of the air filter 63 is reversed, and the air filter 63 is moved rightward as shown in FIG. 11(c). When the air filter 63 reaches a right end position, the cleaning operation of the air filter device 60 is completed.

In addition to advantages (1) and (2) of the first embodiment, the air filter device 60 of the sixth embodiment has the advantages described below. The electronic device of the sixth embodiment has the same advantages as the first embodiment.

(12) In the sixth embodiment, the unit for reducing or eliminating penetration of the brush into the air filter is formed so that the rotary brush 64 does not contact the air filter 63 at a reversing position of the relative movement of the rotary brush 64 and the air filter 63. Accordingly, in the present embodiment, when reversing the relative movement of the rotary brush 64 and the air filter 63, the frictional resistance produced between the rotary brush 64 and the air filter 63 is eliminated.

(13) Further, in the sixth embodiment, when the air filter 63 returns to the standby position, the rotary brush 64 does not contact the air filter 63. This also eliminates frictional resistance produced between the rotary brush 64 and the air filter 63.

It should be apparent to those skilled in the art that the present invention may be embodied in many other specific forms without departing from the spirit or scope of the invention. Particularly, it should be understood that the present invention may be embodied in the following forms.

In the above embodiments, the rotary brushes 31 and 64 are used to remove dust from the air filters 23 and 63. Instead of such rotation type brushes, a brush with bristles extending in the same direction may be used. In this case, distal parts of brush bristles are pressed against the air filters 23 and 63 to remove dust from the air filters 23 and 63.

In the first to fourth embodiments, the rotary brush 31 undergoes a single reciprocation in the leftward and rightward directions to complete a cleaning operation. However, such a cleaning operation may be repeated to thoroughly remove dust from the air filter 23.

In the first to fourth embodiments, a clutch may be used in lieu of the gear 34a. In this case, when the clutch is actuated, the rotary brush 31 is not forcibly rotated when the rotary brush 31 moves rightward.

In the sixth embodiment, the rotary brush 64 undergoes a single reciprocation in the leftward and rightward directions to complete a cleaning operation. However, such a cleaning operation may be repeated to thoroughly remove dust from the air filter 63.

In the sixth embodiment, when moving the air filter 63 in the rightward direction, the rotary brush 64 may be brought into contact with the air filter 63 and forcibly rotated without lowering the rotary brush 64 to remove dust when the air filter 63 moves in the leftward and rightward directions.

In the first to fourth embodiments, the standby position is located at the right side of the air filter 23, and the reversing position is located at the left end of the air filter 23. However, the standby position may be located at both left and right sides of the air filter 23. This removes dust regardless of whether leftward movement or a rightward movement is made. In this case, however, the standby position located at the left side should not increase the circulation resistance when the cleaning unit 30 draws in ambient air.

In the first and fourth embodiments, the rotary brush 31 contacts the peripheral frame 24 of the air filter 23 at the reversing position. Instead, the rotary brush 31 may contact the surface of the base material 22 outside the peripheral frame 24 of the air filter 23. The surface of the base material 22 serves as a filter coupling member in the present invention.

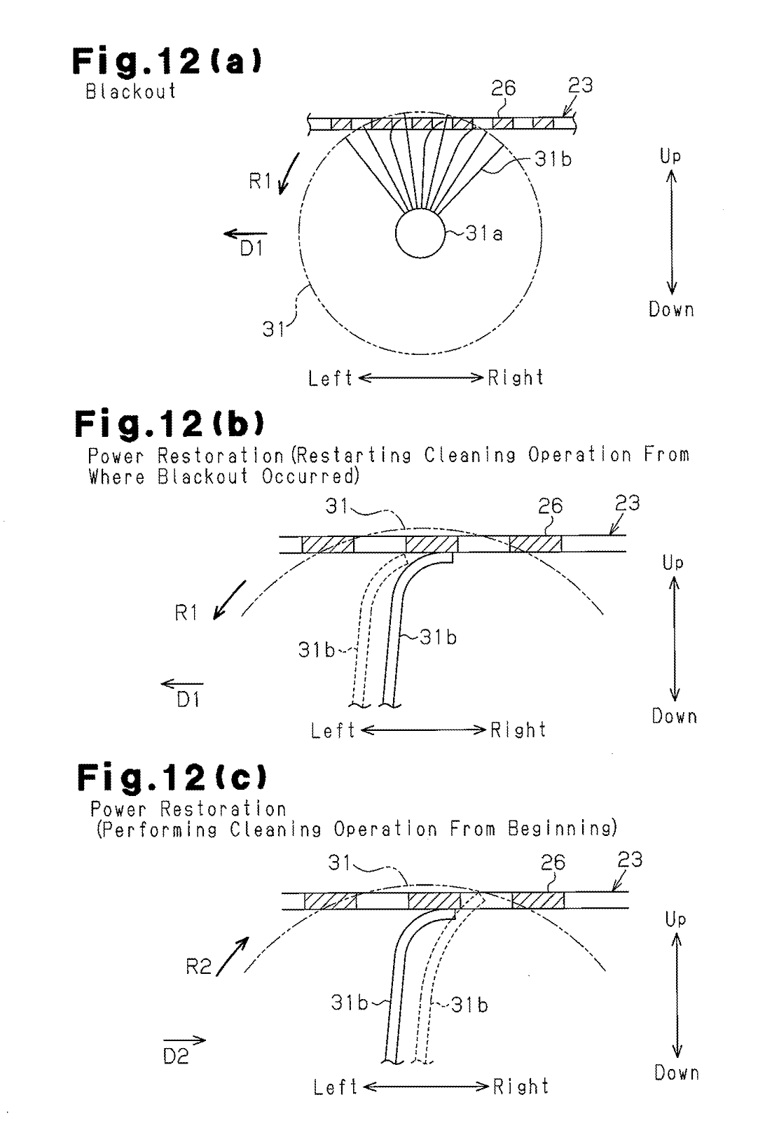

The description of the first to fourth embodiments does not mention how to restart a cleaning operation when a power cut or blackout occurs while the rotary brush 31 is cleaning the air filter 23. However, it is preferable that the cleaning operation be restarted from where it was ended. This reduces the actuation load on the rotary brush in comparison with when rotating and moving the rotary brush 31 in the opposite direction to start the cleaning operation from the beginning. This will now be described in further detail with reference to FIG. 12.

FIG. 12(a) shows a state immediately before the rotary brush 31 is stopped. In this state, the rotary brush 31 performs a cleaning operation by moving in the leftward direction D1, while rotating in the counterclockwise direction R1. Accordingly, the bristles 31b of the rotary brush 31 are as shown in the state shown in FIG. 12(a) when the cleaning operation is stopped. Some of the bristles 31b penetrate the holes of the filtering material 26 and other bristles 31b are bent contacting the surface of the filtering material 26. In this state, the bristles 31b that are in contact with the filtering material 26 are bent and curved toward the right. The actuation load on the rotary brush 31 when the cleaning operation is restarted from this state is affected by the moving direction and rotation direction of the rotary brush 31 when actuated. More specifically, the actuation load differs between when the bristles 31b are straightened without the bending direction of the bristles 31b being changed and when the bristles 31b are straightened as the bending direction of the bristles 31b is reversed.

When restarting the cleaning operation from where it was stopped, the rotary brush 31 is actuated with the bristles 31b contacting the filtering material 26 being bent in the same direction. In contrast, when restarting the cleaning operation so that the rotary brush 31 rotates and moves in directions opposite to that before the rotary brush 31 was stopped, the bending direction of the bristles 31b contacting the filtering material 26 is reversed when the rotary brush 31 is actuated. This increases resistance when the bending of the bristles is reversed, and the load when actuating the rotary brush 31 is increased accordingly.

The difference when restarting the cleaning operation for a bristle 31b pressed against and bent on the surface of the filtering material 26 will now be described.

When restarting the cleaning operation from where it ended, the bending direction of the bristle 31b remains the same as shown in FIG. 12(b). The bristle 31b shown by the solid lines moves in the leftward direction D1, and the distal part of the bristle 31b is rotated in the counterclockwise direction R1. As a result, the bristle 31b shifts to the state shown by the broken lines. Accordingly, the force pressing the bristle 31b against the surface of the filtering material 26 decreases as the rotary brush 31 moves and rotates.

In contrast, when restarting the cleaning operation so that the rotary brush 31 rotates and moves in directions opposite to that before the rotary brush 31 was stopped, as shown in FIG. 12(b), the bristle 31b cannot change its bending direction when contacting the surface of the filtering material 26. Thus, the bristle 31b shown by the solid lines rotates in the clockwise direction R2 but penetrates a hole of the filtering material as shown by the broken lines. Accordingly, the force pressing the bristle 31b against the surface of the filtering material 26 increases as the rotary brush 31 moves and rotates. In this manner, the actuation load of the rotary brush 31 increases as compared with when restarting the cleaning operation from where it ended.

For this reason, in this modification, if the cleaning operation is temporarily stopped and then restarted when power is restored, the rotary brush 31 continues from where it was stopped and starts rotation and movement in the same direction.

The present examples and embodiments are to be considered as illustrative and not restrictive, and the invention is not to be limited to the details given herein, but may be modified within the scope and equivalence of the appended claims.

1. An air filter device comprising:
an air filter that removes dust from air drawn into a device, wherein the air filter includes an air filter surface;
a brush including bristles, wherein the brush removes dust from the air filter, and the brush and the air filter are relatively moved in a direction orthogonal to a longitudinal direction of the brush while distal parts of the bristles of the brush penetrate the air filter surface to remove dust from the air filter; and
a unit for reducing or eliminating penetration that reduces or eliminates penetration of the brush into the air filter when relative movement of the brush and the air filter is stopped.

2. The air filter device according to claim 1, wherein
the relative movement of the brush and the air filter is at least a single reciprocation over a predetermined distance, and
the unit for reducing or eliminating penetration reduces or eliminates penetration of the brush into the air filter when the relative movement is stopped or reversed.

3. The air filter device according to claim 1, wherein
the brush is fixed, and
the air filter moves relative to the brush.

4. The air filter device according to claim 1, wherein
the brush includes a rotary brush and reciprocates on the air filter surface while rotating, and
the air filter is fixed.

5. The air filter device according to claim 1, wherein the unit for reducing or eliminating penetration includes a frame for the filter or a filter coupling member arranged to contact the entire brush in the longitudinal direction or the distal parts of some of the bristles when the relative movement is stopped or reversed.

6. The air filter device according to claim 1, wherein the unit for reducing or eliminating penetration is configured by decreasing a dimension of the air filter in the longitudinal direction of the brush at a location where the relative movement of the brush and the air filter is stopped or reversed.

7. The air filter device according to claim 1, wherein
the air filter includes a portion having a dimension in the longitudinal direction of the brush that is smaller at a position where the relative movement of the brush and the air filter is stopped or reversed than where the relative movement is performed, and
the unit for reducing or eliminating penetration includes a contact portion arranged next to the portion of the air filter at the position where the relative movement of the brush and the air filter is stopped or reversed.

8. The air filter device according to claim 1, wherein the unit for reducing or eliminating penetration is configured by increasing the distance between the brush and the air filter surface in a direction perpendicular to the air filter surface at a position where the relative movement of the brush and the air filter is stopped or reversed.

9. The air filter device according to claim 1, wherein the unit for reducing or eliminating penetration is configured to relatively move the brush and the air filter to increase the distance between the brush and the air filter surface in a direction perpendicular to the air filter surface from a position where the relative movement of the brush and the air filter is performed to a position where the relative movement of the brush and the air filter is stopped or reversed.

10. The air filter device according to claim 4, wherein the unit for reducing or eliminating penetration includes at least one open space that receives the brush outside the air filter as viewed from a direction perpendicular to the air filter surface when the relative movement of the brush and the air filter is stopped and/or when the relative movement of the brush and the air filter is reversed.

11. An electronic device comprising an air filter device, wherein the air filter device includes:
an air filter that removes dust from air drawn into a electronic device, wherein the air filter includes an air filter surface;
a brush including bristles, wherein the brush removes dust from the air filter, and the brush and the air filter are relatively moved in a direction orthogonal to a longitudinal direction of the brush while distal parts of the bristles of the brush penetrate the air filter surface to remove dust from the air filter; and
a unit for reducing or eliminating penetration that reduces or eliminates penetration of the brush into the air filter when relative movement of the brush and the air filter is stopped.
